(19) United States
(12) Patent Application Publication
(10) Pub. No.: US 2004/0185287 A1
(43) Pub. Date: Sep. 23, 2004

(54) Adhesive tie material containing an inorganic filler

(76) Inventors: Tricia Susan Reighard, Loveland, OH (US); James Irvin Marchman, Cincinnati, OH (US); Alexander Craig Bushman, Loveland, OH (US)

Correspondence Address: MCCARTER & ENGLISH LLP, CITYPLACE I, 185 ASYLUM STREET, HARTFORD, CT, 06103, US

(21) Appl. No.: 10/391,714

(22) Filed: Mar. 19, 2003

(51) Int. Cl. B32B 5/16

(52) U.S. Cl. 428/515; 428/330

(57) ABSTRACT

A laminate for use in producing paperboard based laminated structures for beverage containers prepared by applying a layer of EVOH, nylon, or PET onto the paperboard, coating a unique tie layer comprising an anhydride-modified polyolefin based tie resin and an inorganic filler onto said layer of EVOH, nylon, or PET and applying a polyolefin layer onto the tie layer. The paperboard structure provides improved end use performance in fabrication and importantly cost savings.

### FIELD OF THE INVENTION

This invention relates to an adhesive tie material containing an inorganic filler and to a paperboard laminate which makes use of such an unique adhesive tie material. More particularly, the invention relates to an adhesive tie material comprising an anhydride-modified polyolefin based tie resin compounded with an inorganic filler.

### BACKGROUND OF THE INVENTION

In the past, calcium carbonate addition to polyolefins including low density polyethylene (LDPE) and high density polyethylene (HDPE) has been known for increasing adhesion to a number of substrates, particularly clay coated board.

The use of anhydride-modified polyolefin based tie layer materials combined with inorganic fillers for use in liquid beverage packaging is neither discussed nor suggested by the prior art. Prior to the instant invention, it was a common concern that the inorganic filler particularly calcium carbonate would react with the anhydride functionality liberating carbon dioxide and resulting in poor adhesion to the surrounding layers and in particular to thermoplastics such as polyamides (nylons), ethylene vinyl alcohol copolymers (EVOH), and polyethylene terephthalates (PET) that do not adhere directly to polyolefins.

It is an object of the present invention to provide an adhesive tie material for preserving adhesion of polyolefin layers to EVOH, nylon, and PET at a reduced cost.

It is a further object of the invention to provide an adhesive tie material utilizing an anhydride-modified polyolefin based resin with an inorganic filler such as calcium carbonate.

It is yet a further object to provide a laminate in which an adhesive tie material comprising an anhydride-modified polyolefin based resin filled with an inorganic filler is utilized for preserving adhesion of EVOH, nylon, and/or PET layers to a polyolefin layer at a reduced cost.

Yet another object of the invention is to provide laminate structures for use in preparing containers and cartons for juices, milk, punches and other beverages at reduced costs.

### SUMMARY OF THE INVENTION

According to the present invention, there is now provided an adhesive tie material comprising an anhydride-modified polyolefin having an inorganic filler incorporated therein. The invention can be used in structures of coated paperboard for use in the production of containers and cartons for products such as juices, punches, milk and other beverages, which structures are made from a laminate having a paperboard substrate, one or more nylon, EVOH, or PET layers overlying the interior surface of the substrate, and one or more polyolefin layers adhered to the one or more nylon, EVOH, or PET layers via an adhesive tie layer comprising an anhydride modified polyolefin having incorporated therein an inorganic filler. A layer of polyolefin is preferably coated on the exterior surface of the paperboard substrate.

The particulate filler useful for making the adhesive tie layer can be an inorganic or organic material and is preferably a rigid material.

Specific examples of inorganic particulate fillers include:

metal carbonates, such as

barium carbonate;

calcium carbonate; and

magnesium carbonate;

metal hydroxides, such as,

aluminum hydroxide; and

magnesium hydroxide;

metal oxides, such as,

calcium oxide;

magnesium oxide;

titanium oxide;

titanium dioxide and

zinc oxide;

metal sulfates, such as,

barium sulfate

calcium sulfate; and

magnesium sulfate;

clay;

kaolin;

talc;

silica;

diatomaceous earth;

alumina

mica

glass powder; and

zeolites.

Although the invention will be hereinafter described with reference to inorganic particulate filler materials, organic particulate materials can also be used as fillers, as for example, finely divided cellulosic fibers, and in particular such fibers obtained from wood pulps as used in the paper industry.

Commercial examples of suitable particulate filler concentrates include Heritage HM-10 (Heritage Plastics) and Omyacarb 2SST (OMYA, Inc.). These filler concentrates contain the filler, in this case calcium carbonate, at loadings of about 30 to about 80%, preferably about 50 to about 75% by weight of the carrier resin.

The average size of the particulate filler should be about 0.1 micron to about 10 microns, preferably, about 0.5 microns to about 5 microns, and more preferably about 0.8 microns to about 3 microns.

Representative of preferred fillers are calcium carbonate, clay, TiO₂, and silica. Calcium carbonate is a particularly preferred filler because it is relatively inexpensive and readily available.

The calcium carbonate or equivalent filler is generally available as a masterbatch in LDPE, LLDPE, or other polyolefin. Heritage HM-10 concentrate which is 75% calcium carbonate and 25% LLDPE is an instance of a particularly preferred filler.

The anhydride modified polyolefin is a member selected from the group consisting of anhydride modified LDPE, anhydride modified linear low density polyethylene (LLDPE), anhydride modified HDPE, anhydride modified ethylene vinyl acetate copolymer, ethylene ethyl acrylate maleic anhydride copolymer, and ethylene butyl acrylate maleic anhydride terpolymer, and is preferably a Plexar product such as PX 175, PX 5125, or PX 1164 available from Equistar Chemicals, LP.

Acceptable polyamides can be, but are not limited to, nylon 6, nylon 66, nylon 10, nylon 6-10, nylon 12, amorphous nylons, MXD-6, nylon nanocomposites, nylon combined with inorganic fillers (such as talc or kaolin), and blends of nylon with other polymers (such that the nylon remains the continuous phase).

Suitable EVOH materials can be, but are not limited to, ethylene vinyl alcohol copolymers containing 26-44 mole % ethylene, oxygen scavenging EVOH materials, EVOH nanocomposites, EVOH combined with other inorganic fillers (such as talc or kaolin), and blends of EVOH with other polymers (such that the EVOH remains the continuous phase). Polyvinyl alcohols (PVOH) can also be used.

Acceptable polyethylene terephthalates include, but are not limited to, glycol-modified polyethylene terephthalates, acid-modified polyethylene terephthalates, PET nanocomposites, PET combined with other inorganic fillers (such as talc or kaolin), and blends of PET with other polymers (such that the PET remains the continuous phase).

Suitable polyolefins include, but are not limited to, LDPE, HDPE, LLDPE, polypropylene, cyclic olefin copolymers, and blends thereof.

The filler is dry blended with the tie resin at the time of processing, such that the final loading levels are 1-55 wt % filler and typically 7.5-22.5 wt % filler.

The adhesive tie layer has a coating weight of about 0.1 to about 20 lb./3000 sq. ft., preferably about 0.1 to about 14 lbs./3000 sq. ft., and more preferably about 1 to about 5 lbs/3000 sq. ft.

The basis weight of the paperboard utilized in preparing the laminate structures for their intended use as cartons and containers can vary from 80 to 300 lbs./3000 sq. ft. with a preference of 140-280 lbs./3000 sq. ft.

Applying the tie layer and other layers can be achieved by either coextrusion or by standard lamination or extrusion lamination processes.

### DETAILED DESCRIPTION OF THE INVENTION

A masterbatch of 75 weight % calcium carbonate in 25 weight % LDPE was used. In all of the embodiments as hereinafter described, the masterbatch was dry blended with Plexar tie resin at the time of processing.

Blends of 10, 15, 20, 30, 40, 50, 60, and 70 weight % calcium carbonate masterbatch (final loading levels of 7.5, 11.25, 15, 22.5, 30, 37.5, 45, and 52.5 weight %, respectively) in Plexar PX 5125 tie were extruded into monolayer cast films with only a slight increase in barrel pressure observed with increasing calcium carbonate final loadings from 7.5 weight % to 22.5 weight %. At 30 weight % to 52.5 weight % final loadings, the pressure increased in a more exponential fashion. However, film quality was excellent at all loadings, and no reaction between the calcium carbonate and the maleic anhydride functional groups was observed. Plexar PX 5125 is an appropriate tie for nylon or EVOH to polyolefins.

Blends of 20 and 60 weight % calcium carbonate masterbatch (final loading levels of 15 and 45 weight %, respectively) in Plexar PX 1164 tie were also extruded into monolayer cast films. The PX 1164 contains an ethylene vinyl acetate copolymer base combined with the maleic anhydride functionality, and is an appropriate tie layer for PET to polyolefins. Increase in extruder barrel pressure was equivalent to that observed with PX 5125 blends. Film quality was again excellent at both loadings.

Laminate structures comprising two-layer coextrusions of Plexar PX 5125 tie containing 30 weight % calcium carbonate (final loading level of 22.5 weight %) with LDPE, nylon 6, and EVOH were prepared. The structures all showed excellent interlayer adhesion and could not be separated using a manual tape pull test. Therefore, the addition of calcium carbonate at these loadings did not disrupt reactive adhesion between the maleic anhydride functionality and the polar groups of nylon or EVOH, or negatively impact the chain entanglement that results in adhesion between the tie resin backbone and polyolefins such as LDPE.

Laminate structures comprising two-layer coextrusions of Plexar PX 5125 tie containing 0, 20, 40, and 60 weight % calcium carbonate (final loading levels of 0, 15, 30, and 45 weight %) and nylon 6 were prepared. In addition, a two-layer coextrusion of LDPE and nylon 6 was made. The LDPE/nylon 6 film was easily separated into two layers. As expected, the tie layer containing 0 weight % calcium carbonate was completely adhered to the nylon layer. Furthermore, the tie/nylon 6 films containing 20, 40, and 60 weight % calcium carbonate could not be separated by either the manual tape pull test or via Instron testing again demonstrating that the addition of calcium carbonate to the tie layer does not adversely affect adhesion to nylon 6.

Representative laminate structures (with coat weights as listed in the table which follows in lbs./3000 sq. ft.) were then prepared.

| 1 | 2 | 3 | 4 |
|---|---|---|---|
| Control | Invention | Control | Invention |
| 12 LDPE | 12 LDPE | 12 LDPE | 12 LDPE |
| Basestock | Basestock | Basestock | Basestock |
| 5 Nylon | 5 Nylon | 5 Nylon | 5 Nylon |
| 14 Tie | 14 (Tie + CaCO3) | 1.5 Tie | 1.5 (Tie + CaCO3) |
| 8 LDPE | 8 LDPE | 14 LDPE | 14 LDPE |

Structures 1 and 2 were produced using a two layer coextrusion of nylon/tie followed by an LDPE overcoat, while structures 3 and 4 were produced as a three layer coextrusion of nylon/tie/LDPE.

Both of the structures corresponding to the invention (structures 2 and 4) were produced using 20 weight % calcium carbonate masterbatch (final loading of 15 weight % calcium carbonate) in 80% Plexar PX 5125. No reaction between the calcium carbonate and the maleic anhydride functional groups was observed. The melt curtain was stable and clear, no significant increase in barrel pressure was observed, and overall quality of the coated board was excellent.

All of the structures 1-4 were converted to half gallon gable top cartons, filled with skim milk, and tested for bulge performance on a weekly basis over a standard 21 day shelf life. All four structures had equivalent bulge performance across the 21-day test period. One day after filling, another set of filled cartons were shaken on a vibration table to evaluate bottom durability. After 60 minutes of aggressive shaking, structures 1 and 2 each exhibited 1.75 bottom leaks per 10 cartons. Structure 4 performed better than structure 3 with 11.25 and 16 leaks per 10 cartons, respectively. The carton performance which was obtained with the addition of calcium carbonate to the resin was at least as good if not better than the controls without calcium carbonate. The use of the filler resulted in a 10% cost savings compared to the controls due to the lower cost of the filler in comparison to the cost of the tie resin.

The invention can be used in structures of coated paperboard for use in the production of containers and cartons for products such as juices, punches, milk and other beverages, which structures are made from a laminate having a paperboard substrate, one or more nylon, EVOH, or PET layers overlying the interior surface of the substrate, and one or more polyolefin layers adhered to the one or more nylon, EVOH, or PET layers via an adhesive tie layer comprising an anhydride modified polyolefin having incorporated therein an inorganic filler. A layer of polyolefin is preferably coated on the exterior surface of the paperboard substrate.

The layers can be achieved by either coextrusion or by standard lamination or extrusion lamination processes.

What is claimed is:

1. An adhesive tie layer material comprising a blend of an anhydride modified polyolefin and an inorganic filler selected from the group consisting of metal carbonates, metal hydroxides, metal oxides, metal sulfates, clay, kaolin, talc, silica, diatomaceous earth, alumina, mica, glass powder and zeolites.

2. An adhesive tie layer material according to claim 1 wherein said inorganic filler is selected from the group consisting of calcium carbonate, clay, talc, titanium dioxide and silica.

3. An adhesive tie layer material according to claim 1 wherein said metal carbonate is calcium carbonate.

4. An adhesive tie layer material according to claim 2 wherein said inorganic filler is present with a loading of 1-55 weight percent.

5. An adhesive tie layer material according to claim 2 wherein said inorganic filler is present with a loading of 7.5-22.5 weight percent.

6. An adhesive tie layer material according to claim 2 wherein said anhydride modified polyolefin is a member selected from the group consisting of anhydride modified low density polyethylene, anhydride modified linear low density polyethylene, anhydride modified high density polyethylene, anhydride modified ethylene vinyl acetate copolymer, ethylene ethyl acrylate maleic anhydride copolymer and ethylene butyl acrylate maleic anhydride terpolymer.

7. A laminate for producing a beverage container comprising from the outer surface to the inner surface contacting the container's contents
a) a paperboard substrate having an exterior and an interior surface;
b) a layer of polyolefin coated on the exterior surface of the paperboard substrate;
c) a layer of a member selected from the group of thermoplastics that do not adhere to polyolefins applied interior to the surface of the paperboard substrate;
d) a second layer of polyolefin; and
e) a layer of an adhesive tie layer material comprising a blend of an anhydride modified polyolefin with an inorganic filler bonding the second layer of polyolefin and layer of said member selected from the group of thermoplastics that do not adhere to polyolefins.

8. A laminate according to claim 7 wherein said tie layer material is a member selected from the group consisting of anhydride modified low density polyethylene, anhydride modified linear low density polyethylene, anhydride modified high density polyethylene, anhydride modified ethylene vinyl acetate copolymer, ethylene ethyl acrylate maleic anhydride copolymer and ethylene butyl acrylate maleic anhydride terpolymer.

9. A laminate according to claim 7 wherein said inorganic filler is a member selected from the group consisting of calcium carbonate, talc, clay, titanium dioxide and silica.

10. A laminate according to claim 7 wherein said inorganic filler is calcium carbonate.

11. A laminate according to claim 7 wherein said anhydride modified polyolefin is anhydride modified linear low density polyethylene.

12. A laminate according to claim 7 wherein said blend contains as said filler calcium carbonate in a final amount of 1-55 weight percent.

13. A laminate according to claim 7 wherein said blend contains as said filler calcium carbonate in a final amount of 7.5-22.5 weight percent.

14. A laminate according to claim 7 wherein said adhesive tie layer has a coating weight of about 0.1 to about 14 lbs./3000 sq. ft.

15. A laminate for producing a beverage container comprising from the outer surface to the inner surface contacting the containers contents,
a) a paperboard substrate having an exterior and an interior surface;
b) a layer of polyolefin coated on the exterior surface of the paperboard substrate;
c) a layer of a member selected from the group consisting of nylon, EVOH and PET applied interior to the paperboard surface;
d) a second layer of polyolefin; and
e) a layer of a blend of anhydride modified polyolefin and calcium carbonate bonding the second layer of polyolefin to said group member layer.

16. A laminate for producing a beverage container comprising from the outer surface to the inner surface contacting the containers contents,
a) a paperboard substrate having an exterior and an interior surface;
b) a layer of polyolefin coated on the exterior surface of the paperboard substrate;
c) a layer of a member selected from the group consisting of nylon, EVOH and PET applied onto the interior surface of the paperboard substrate;
d) a second and innermost layer of polyolefin that will contact the contents of the container; and
e) a layer of a blend of anhydride modified polyolefin and calcium carbonate bonding the second and innermost layer of polyolefin to said group members.

17. A blank for use in producing a container for juice, punches, milk and other beverages constructed from a laminate according to claim 7.

18. A container for juices, punches, milk and other beverages constructed from a laminate structure as claimed in claim 7.

19. A process for producing a paperboard product including a layer of a thermoplastic which is a member selected from the group consisting of nylon, EVOH and PET and an adjacent layer of polyolefin which comprises applying an adhesive tie layer of a blend of anhydride modified polyolefin and calcium carbonate intermediate said thermoplastic layer and said adjacent polyolefin layer.

20. A process according to claim 19 wherein said adhesive tie layer is applied in an amount of about 0.1 to about 20 lbs./3000 sq. ft.

21. A process according to claim 19 wherein said adhesive tie layer is applied in an amount of about 0.1 to about 14 lbs/3000 sq. ft.

22. A process according to claim 19 wherein said adhesive tie layer is applied in an amount of about 1.0 to about 5 lbs/3000 sq. ft.

23. An adhesive tie layer material comprising a blend of anhydride modified polyolefin and an organic particulate filler comprising finely divided cellulosic fibers.

24. A laminate comprising a layer of a member selected from the group consisting of nylon, EVOH and PET, a layer of polyolefin selected from the group consisting of LDPE, HDPE, LDPE, polypropylene, cyclic olefin copolymers and blends thereof and a layer of an anhydride modified polyolefin with an inorganic filler bonding the layer of polyolefin to said member selected from the group consisting of nylon, EVOH and PET.

25. A laminate for producing a beverage container comprising from the outer surface to the inner surface contacting the containers contents,
a) a paperboard substrate having an exterior and an interior surface;
b) a layer of polyolefin coated on the exterior surface of the paperboard substrate;
c) at least one additional layer of polyolefin;
d) at least two layer combinations applied interior to the paperboard substrate, each combination comprising 1) a layer of a member selected from the group consisting of nylon, EVOH and PET, 2) a layer of polyolefin and 3) a layer of a blend of anhydride modified polyolefin and calcium carbonate bonding each of said layers of polyolefin to said layer of said group member.
